(19) United States
(12) Patent Application Publication
(10) Pub. No.: US 2025/0263118 A1
(43) Pub. Date: Aug. 21, 2025

(54) VEHICLE CONTROL METHOD, ELECTRONIC DEVICE, AND STORAGE MEDIUM

(71) Applicant: VisionNav Robotics USA Inc., Acworth, GA (US)

(72) Inventors: You LIU, SHENZHEN (CN); Mu FANG, SHENZHEN (CN); Yujie LU, SHENZHEN (CN)

(21) Appl. No.: 19/004,747

(22) Filed: Dec. 30, 2024

(30) Foreign Application Priority Data
Feb. 19, 2024 (CN) 202410188125.5

(51) Int. Cl. B62D 6/00; B60W 30/10; B62D 5/04; B62D 15/02

(52) U.S. Cl. CPC B62D 6/002; B62D 5/046; B62D 15/025; B60W 30/10; B60W 2710/207

(57) ABSTRACT

Embodiments of the present application discloses a vehicle control method and apparatus, an electronic device and a storage medium, the vehicle includes at least one steering wheel, and the method includes: detecting a first distance between the vehicle and a first track, and a second distance between the vehicle and a second track, determining, according to the first distance and the second distance, offset information of a symmetrical centerline of the vehicle relative to a track centerline, determining, according to the offset information and position information corresponding to the to-be-controlled steering wheel, a first rotation angle control quantity of a to-be-controlled steering wheel, and controlling, according to the first rotation angle control quantity, rotation of the to-be-controlled steering wheel, such that during travel of the vehicle, the symmetrical centerline of the vehicle overlaps with the track centerline.

### CROSS REFERENCE TO RELATED APPLICATIONS

The application claims priority to Chinese Patent Application No. 202410188125.5, filed on Feb. 19, 2024, the entire content of which is incorporated herein by reference.

### TECHNICAL FIELD

The application relates to an automatic control technology field, and in particular, to a vehicle control method and apparatus, an electronic device, and a storage medium.

### BACKGROUND

Unmanned forklifts have a variety of functions, including handling, stacking, unloading and picking. These functions make unmanned forklifts have a wide application prospect in logistics and warehousing fields. The motion control of unmanned forklift is the key technology to realize the high-precision and high-reliability operation of automatic guided vehicles.

### SUMMARY

Embodiments of the application disclose a vehicle control method and apparatus, an electronic device, and a storage medium, capable of controlling a vehicle to travel along a track centerline, which improves the control accuracy of a vehicle traveling in an environment with a physical track.

Embodiments of the application disclose a vehicle control method, applied to a vehicle including at least one steering wheel, where the vehicle is drivable between a first track and a second track, and the method includes: detecting a first distance between the vehicle and the first track, and detecting a second distance between the vehicle and the second track; determining, according to the first distance and the second distance, offset information of a symmetrical centerline of the vehicle relative to a track centerline; the first track and the second track are axisymmetric with respect to the track centerline; determining, according to the offset information and position information corresponding to a to-be-controlled steering wheel, a first rotation angle control quantity of the to-be-controlled steering wheel; where the position information corresponding to the to-be-controlled steering wheel is used to indicate a set position of the to-be-controlled steering wheel on the vehicle, and the to-be-controlled steering wheel is any one of the at least one steering wheel; and controlling, according to the first rotation angle control quantity, rotation of the to-be-controlled steering wheel, to change a travel direction of the to-be-controlled steering wheel, such that during travel of the vehicle, the symmetrical centerline of the vehicle overlaps with the track centerline.

Embodiments of the application discloses a vehicle control apparatus, applied to a vehicle including at least one steering wheel, where the vehicle is drivable between a first track and a second track, and the apparatus includes: a detection module configured to: detect a first distance between the vehicle and the first track, and detect a second distance between the vehicle and the second track; an offset determination module configured to: determine, according to the first distance and the second distance, offset information of a symmetrical centerline of the vehicle relative to a track centerline, where the first track and the second track arc axisymmetric with respect to the track centerline; a control determination module configured to: determine, according to the offset information and position information corresponding to a to-be-controlled steering wheel, a first rotation angle control quantity of the to-be-controlled steering wheel; where the position information corresponding to the to-be-controlled steering wheel is used to indicate a set position of the to-be-controlled steering wheel on the vehicle, and the to-be-controlled steering wheel is any one of the at least one steering wheel; a rotation angle control module configured to: control, according to the first rotation angle control quantity, rotation of the to-be-controlled steering wheel, to change a travel direction of the to-be-controlled steering wheel, such that during travel of the vehicle, the symmetrical centerline of the vehicle overlaps with the track centerline.

Embodiments of the application discloses a vehicle, where the vehicle is drivable between a first track and a second track, and the vehicle includes: at least one steering wheel configured to drive the vehicle to perform translational movement and rotary movement; and a memory and a processor, where the memory stores a computer program, and when the computer program is executed by the processor, the processor is configured to implement any one of vehicle control methods disclosed in the embodiments of the application.

Embodiments of the application discloses a computer-readable storage medium, storing a computer program, the computer program is executed by one or more processors to implement any one of vehicle control methods disclosed in the embodiments of the application.

### BRIEF DESCRIPTION OF DRAWINGS

To describe the technical solutions in the embodiments of the application more clearly, the accompanying drawings required for describing the embodiments are briefly described hereinafter. Apparently, the accompanying drawings in the following description show merely some embodiments of the application, and a person of ordinary skill in the art may obtain other accompanying drawings from these accompanying drawings without creative efforts.

FIG. 1 is an application scenario diagram of a vehicle control method according to an embodiment of the application.

FIG. 2 is a flow diagram of a vehicle control method according to an embodiment of the application.

FIG. 3A is a position relationship diagram between a vehicle and tracks according to an embodiment of the application.

FIG. 3B is another position relationship diagram between a vehicle and tracks according to an embodiment of the application.

FIG. 4 is a flow diagram of another vehicle control method according to an embodiment of the application.

FIG. 5 is a structure diagram of a vehicle chassis according to an embodiment of the application.

FIG. 6 is a flow diagram for determining offset information according to an embodiment of the application.

FIG. 7A is a position relationship diagram of sub-distances according to an embodiment of the application.

FIG. 7B is a set position diagram of a laser rangefinder according to an embodiment of the application.

FIG. 7C is another position relationship diagram between a vehicle and tracks according to an embodiment of the application.

FIG. 7D is a position relationship diagram of a fifth laser rangefinder and tracks according to an embodiment of the application.

FIG. 8A to FIG. 8C are respectively schematic diagrams of a correspondence between a deflection steering angle and a distance vector with time when the vehicle travels forward according to an embodiment of the application.

FIG. 9A to FIG. 9C are respectively schematic diagrams of a correspondence between a deflection steering angle and a distance vector with time when the vehicle travels backward according to an embodiment of the application.

FIG. 10 is a flow diagram of another vehicle control method according to an embodiment of the application.

FIG. 11 is a structure diagram of another vehicle chassis according to an embodiment of the application.

FIG. 12 is a structure diagram of a vehicle control apparatus according to an embodiment of the application.

FIG. 13 is a structure diagram of a controller according to an embodiment of the application.

### DETAILED DESCRIPTION

The technical solutions in the embodiments of the present application will be clearly and completely described with reference to accompanying drawings in the embodiments of the present application. Apparently, the described embodiments are only a part of the embodiments of the present application, but not all of the embodiments. All other embodiments obtained by those skilled in the art without creative effort based on the embodiments of the application fall within the scope of the application.

The terms “include”, “have” and any variation thereof in the specification and claims of the application and the accompanying drawings are intended to encompass non-exclusive inclusion. For example, processes, methods, systems, products or devices including a series of steps or units are not limited to the listed steps or units, but optionally, include unlisted steps or units as well, or optionally, include other steps or units inherent to the processes, methods, products or devices as well.

Embodiments of the application disclose a vehicle control method and apparatus, an electronic device, and a storage medium, capable of controlling a vehicle to travel along a track centerline, which improves the control accuracy of a vehicle traveling in an environment with a physical track.

In the related art, the motion solutions of unmanned forklifts are generally based on satellite positioning, odometer positioning, or simultaneous localization and mapping (SLAM) laser positioning, and use front wheel feedback (also known as the Stanley method) to achieve automatic driving of unmanned forklifts along a specified path. However, the above solutions are only applicable in open environments. For the control of unmanned forklifts with physical track constraints, since there is no preset specified path, it is impossible to control the unmanned forklift to travel in a prescribed manner in the track-constrained environment.

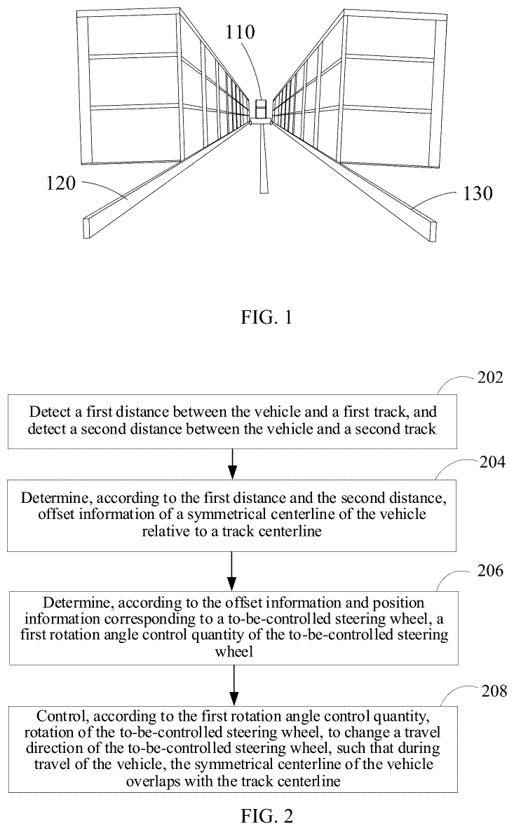

The vehicle control method provided in the application may be applied to the application environment as illustrated in FIG. 1. The method is applied to a vehicle 110, the vehicle 110 is drivable between a first track 120 and a second track 130. The first track 120 and the second track 130 are arranged in parallel, and the first track 120 and the second track 130 are fixedly connected to a road surface on which the vehicle 110 travels. A distance between the first track 120 and the second track 130 is greater than a width of the vehicle 110, for example, greater than a size of the vehicle 110 in a width direction of the vehicle 110. The first track 120 and the second track 130 may be made of a rigid material, and surfaces of the first track 120 and the second track 130 are smooth to ensure the reliability of the distance, between the vehicle 110 and the track, detected by the vehicle 110.

The vehicle 110 may include at least one steering wheel, which may be set on a chassis of the vehicle 110 and is configured to drive the vehicle 110 to perform translational movement and rotatory movement. For example, the steering wheel may be set on the symmetrical centerline of the vehicle 110, or it may also be set at a position except on the symmetrical centerline of the vehicle 110. In some embodiments, the vehicle 110 may include but is not limited to forklifts, e.g., stacking forklifts, counterweight forklifts, forward-moving forklifts, and picking forklifts, etc.

In some embodiments, the vehicle 110 may further include a distance detection sensor, which may be set on the vehicle 110 and is configured to detect a distance between the distance detection sensor and the first track 120, as well as a distance between the distance detection sensor and the second track 130, so as to obtain the distance between the vehicle 110 and the first track 120, and the distance between the vehicle 110 and the second track 130, respectively. In some embodiments, the distance detection sensor may include but is not limited to a laser rangefinder and a sonic sensor.

Referring to FIG. 2, which illustrates a flow diagram of a vehicle control method according to an embodiment of the application, where the vehicle control method described in FIG. 2 is applicable to the vehicle illustrated in FIG. 1.

As illustrated in FIG. 2, the method includes step 202 to step 208.

At step 202, a first distance between the vehicle and a first track is detected, and a second distance between the vehicle and a second track is detected.

It should be noted that, the first distance is the distance between the vehicle and the first track, and the second distance is the distance between the vehicle and the second track. By setting the distance detection sensor on the vehicle, the vehicle may acquire the distance data collected by the distance detection sensor, determine the first distance and the second distance according to the distance data collected by the distance detection sensor, and determine the position of the vehicle between the first track and the second track and posture of the vehicle according to the first distance and the second distance. And distance detection sensors may also be set on the first track and the second track, to detect the first distance between the vehicle in and the first track and the second distance between the vehicle and the second track, respectively.

In an embodiment, the distance detection sensor includes a first distance detection sensor and a second distance detection sensor, where the first distance detection sensor is on a first side surface of the vehicle, and the second distance detection sensor is on a second side surface of the vehicle, where the first side surface is opposite to the second side surface. Detecting the first distance between the vehicle and the first track and the second distance between the vehicle and the second track by the distance detection sensor includes: detecting the first distance between the vehicle and the first track by the first distance detection sensor, and detecting the second distance between the vehicle and the second track by the second distance detection sensor. In the embodiment, by respectively arranging distance detection sensors on both sides of the vehicle, the first distance between the vehicle and the first track and the second distance between the vehicle and the second track may be directly acquired without the need for the vehicle to perform conversion, thereby reducing the calculation amount of the processor in the vehicle.

At step 204, offset information of a symmetrical centerline of the vehicle relative to a track centerline is determined according to the first distance and the second distance.

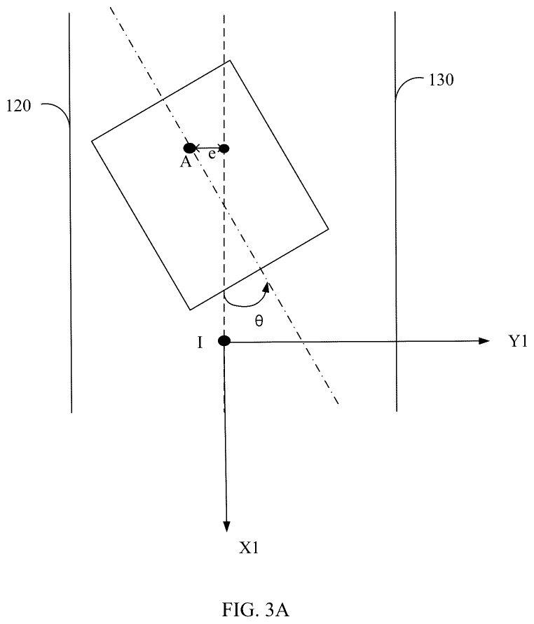

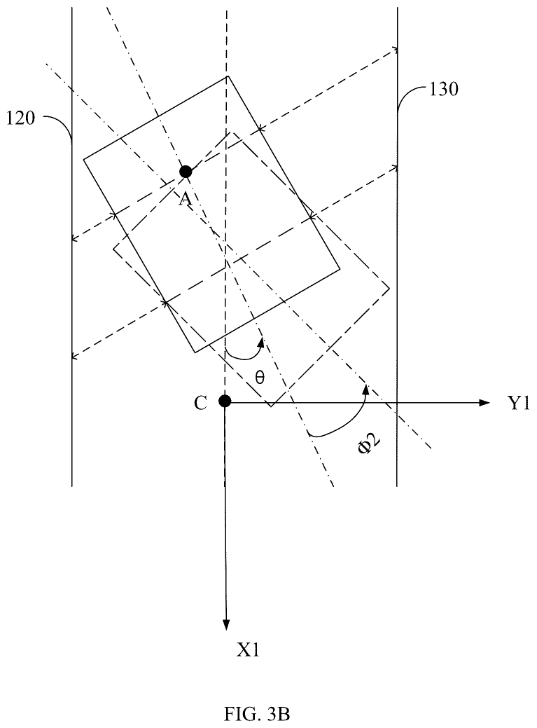

The first track and the second track are axisymmetric with respect to the track centerline, and the symmetrical centerline of the vehicle is the axis of symmetry of the vehicle. Further, the symmetrical centerline is parallel to the length direction of the vehicle, and the offset information is used to indicate the offset degree of the symmetrical centerline of the vehicle relative to the track centerline. If the symmetrical centerline overlaps with the track centerline, it may be considered that the symmetrical centerline has no offset relative to the track centerline. For example, the offset information may include a deflection steering angle of a target point on the symmetrical centerline and a distance vector of the target point from the track centerline. The target point may be any point on the symmetrical centerline except a point where the symmetrical centerline intersects with the track centerline, or may be a point determined according to a set position of the distance detection sensor in the vehicle, to facilitate the determination of the distance vector of the target point. It should be noted that the deflection steering angle is a vector, i.e., the deflection steering angle is a vector with both magnitude and direction, and the distance vector is also a vector with both magnitude and direction. For example, referring to FIG. 3A, a preset three-dimensional coordinate system includes X1 axis, Y1 axis, and Z1 axis (not illustrated in FIG. 3A), the X1 axis direction is parallel to the track centerline, the Y1 axis direction is perpendicular to the track centerline, and the Z1 axis is perpendicular to the paper surface and extends outward. The preset three-dimensional coordinate system conforms to the Cartesian right-handed coordinate system rule, and the coordinate origin I of the preset three-dimensional coordinate system is on the track centerline. The direction of the deflection steering angle θ illustrated in FIG. 3A is the positive direction, i.e., the direction turning from the positive direction of the X1 axis to the positive direction of the Y1 axis is the positive direction. When the symmetrical centerline of the vehicle is parallel to the X1 axis, the deflection steering angle θ is 0, and a range of the deflection steering angle θ is (−π/2, π/2). If the deflection steering angle is positive, it indicates that the direction of the deflection steering angle is the positive direction. If the deflection steering angle is negative, it indicates that the direction of the deflection steering angle is the opposite direction. When the Y1 axis coordinate value corresponding to the target point A is positive, the distance vector e is positive, indicating that the direction of the distance vector is the positive direction. When the Y1 axis coordinate value corresponding to the target point A is negative, the distance vector e is negative, indicating that the direction of the distance vector e is the opposite direction, as illustrated in FIG. 3A.

In an embodiment, determining the offset information of the symmetrical centerline of the vehicle relative to the track centerline according to the first distance and the second distance may include: determining, by an angular motion detection sensor on the vehicle, the travel direction of the vehicle, calculating the difference between the first distance and the second distance as the fifth difference value, and determining, according to the travel direction of the vehicle and the fifth difference value, the offset information of the symmetrical centerline of the vehicle relative to the track centerline. The first distance represents the distance between the vehicle and the first track, and the second distance represents the distance between the vehicle and the second track. Therefore, the distance of the vehicle offset from track centerline may be determined according to the difference value between the first distance and the second distance. Further, according to the angular motion detection sensor, the travel direction of the vehicle, i.e., the orientation of the vehicle, may be determined. Therefore, the offset information of the symmetrical centerline relative to the track centerline may be determined according to the fifth difference value and the travel direction. In some embodiments, the angular motion detection sensor may include a gyroscope. In the embodiment, the vehicle may acquire, by the distance detection sensor, the first distance from the vehicle to the first track and the second distance from the vehicle to the second track, and acquire, by the angular motion detection sensor, the travel direction of the vehicle. According to the first distance, the second distance, and the travel direction, the offset information of the symmetrical centerline relative to the track centerline may be obtained, which improves the speed and accuracy of the vehicle determining the offset information.

At step 206, a first rotation angle control quantity of the to-be-controlled steering wheel is determined according to the offset information and position information corresponding to a to-be-controlled steering wheel.

The to-be-controlled steering wheel is any one of at least one steering wheel in the vehicle, and the position information corresponding to the to-be-controlled steering wheel is used to indicate the set position of the to-be-controlled steering wheel on the vehicle, and the first rotation angle control quantity refers to a control quantity corresponding to an angle at which the to-be-controlled steering wheel needs to rotate. It should be noted that the vehicle is rotatable around a rotation center of the vehicle under the action of at least one steering wheel, and there is a correlation among rotation angles of respective steering wheels, which is determined based on the set position of each steering wheel on the vehicle. Therefore, the vehicle may determine, according to the position information of the to-be-controlled steering wheel (i.e., the set position of the to-be-controlled steering wheel on the vehicle) and the offset information of the symmetrical centerline of the vehicle relative to the track centerline, the first rotation angle control quantity of the to-be-controlled steering wheel, such that the vehicle may control the to-be-controlled steering wheel according to the first rotation angle control quantity, and thus the symmetrical centerline of the vehicle may be restored to overlap with the track centerline within a certain time.

In an embodiment, determining, according to the offset information and the position information corresponding to the to-be-controlled steering wheel, the first rotation angle control quantity of the to-be-controlled steering wheel may include: determining, by the vehicle, according to the offset information and the position information corresponding to the to-be-controlled steering wheel, the first rotation angle that the to-be-controlled steering wheel needs to rotate, and determining, according to the first rotation angle, the first rotation angle control quantity. It should be noted that the first rotation angle is the rotation angle (including magnitude and direction) that the to-be-controlled steering wheel needs to rotate. The vehicle determines the first rotation angle of the to-be-controlled steering wheel according to the offset information and the position information corresponding to the to-be-controlled steering wheel. Then, the first rotation angle control quantity is determined according to the first rotation angle, and the first rotation angle control quantity is sent to the to-be-controlled steering wheel to enable the to-be-controlled steering wheel to rotate according to the first rotation angle control quantity.

In an embodiment, determining, according to the offset information and the position information corresponding to the to-be-controlled steering wheel, the first rotation angle control quantity of the to-be-controlled steering wheel may include: determining, by the vehicle, according to the offset information and the position information corresponding to the to-be-controlled steering wheel, the first offset information corresponding to the to-be-controlled steering wheel, and determining, according to the first offset information, the first rotation angle control quantity of the to-be-controlled steering wheel. It should be noted that, the first offset information may include the first distance vector between the set position of the to-be-controlled steering wheel and the track centerline, and the first deflection steering angle between the current travel direction of the to-be-controlled steering wheel and the track centerline. The travel direction of the to-be-controlled steering wheel may be understood as the direction of the translational movement speed of the to-be-controlled steering wheel, i.e., the to-be-controlled steering wheel performs translational movement by turning and changing a direction, the to-be-controlled steering wheel rotates around a first axis to achieve translational movement of the to-be-controlled steering wheel, and rotates around a second axis to achieve turning and changing a direction of the to-be-controlled steering wheel, where the first axis is the central axis of the to-be-controlled steering wheel, and the second axis is perpendicular to the first axis. The vehicle is rotatable around the rotation center of the vehicle, and the offset information at different positions on the bottom of the vehicle is different, but the offset information corresponds to the position of the steering wheel on the vehicle. Therefore, the vehicle may determine, according to the offset information and the position information corresponding to the to-be-controlled steering wheel, the first offset information corresponding to the to-be-controlled steering wheel, thereby determining the first rotation angle control quantity of the to-be-controlled steering wheel.

In an embodiment, determining, according to the offset information and the position information corresponding to the to-be-controlled steering wheel, the first rotation angle control quantity of the to-be-controlled steering wheel may include: calculating, according to the offset information of the vehicle, the second rotation angle control quantity, and determining, according to the second rotation angle control quantity and the position information corresponding to the to-be-controlled steering wheel, the first rotation angle control quantity of the to-be-controlled steering wheel. The second rotation angle control quantity corresponds to an angle that the symmetrical centerline needs to rotate, i.e., the second rotation angle corresponding to the second rotation angle control quantity is the angle that the symmetrical centerline needs to rotate. It should be noted that, the steering wheels of the vehicle work together to change the travel direction of the vehicle, and there is a correlation among the required rotation angles of respective steering wheels. Therefore, the second rotation angle control quantity of the symmetrical centerline may be calculated first, and then according to the set positions of the respective steering wheels on the vehicle, the first rotation angle control quantity corresponding to each steering wheel is determined. In the embodiment, the second rotation angle control quantity is directly adjusted according to the position information corresponding to the to-be-controlled steering wheel, to obtain the first rotation angle control quantity of the to-be-controlled steering wheel, which may improve the determination speed of the first rotation angle control quantity.

In some embodiments, the offset information may include the deflection steering angle corresponding to the target point A and the distance vector between the target point A on the symmetrical centerline and the track centerline. The target point A is taken as a starting point, and a heading angle of the starting point is set as the deflection steering angle corresponding to the target point A. The point A′ is taken as an end point, and a heading angle of the end point is set to 0 degree, where the distance between point A′ and point A along the track centerline is X (this distance may be set freely according to the required response speed), and point A′ is on the track centerline. The above information is input into the path planning algorithm, to determine a heading angle corresponding to each path point in the path of the vehicle moving from target point A to point A′, and then determine a second rotation angle corresponding to each path point, so as to determine the second rotation angle control quantity. The vehicle travels according to a planned path determined by the path planning algorithm, which may enable the deflection steering angle corresponding to point A′ to be 0 degree when the vehicle arrives at point A′, such that the symmetrical centerline of the vehicle coincides with the track centerline. It should be noted that since the vehicle is rotatable around the rotation center, according to the position relationship of the to-be-controlled steering wheel relative to the rotation center and the position relationship of the target point A relative to the rotation center, through calculation, the conversion relationship between the second rotation angle corresponding to the second rotation angle control quantity and the first rotation angle corresponding to the first rotation angle control quantity may be obtained, thereby the first rotation angle may be obtained, and the first rotation angle control quantity is determined. In some embodiments, the path planning algorithm may use the Hybird A* path planning algorithm or the Dijkstra algorithm.

At step 208, the to-be-controlled steering wheel is controlled to rotate according to the first rotation angle control quantity, to change a travel direction of the to-be-controlled steering wheel, such that during travel of the vehicle, the symmetrical centerline of the vehicle overlaps with the track centerline.

It should be noted that, the chassis of the vehicle may be provided with at least one steering wheel and at least one directional wheel, the at least one directional wheel may be used to drive the vehicle to perform translational movement, the vehicle may send the first rotation angle control quantity to the to-be-controlled steering wheel of the at least one steering wheel, to drive the to-be-controlled steering wheel to rotate, to change a travel direction of the to-be-controlled steering wheel, thereby changing a travel direction of the vehicle.

In some embodiments, the vehicle may send the first rotation angle control quantity to the to-be-controlled steering wheel through a Controller Area Network (CAN) interface, to control the rotation of the to-be-controlled steering wheel. In some embodiments, the steering wheel includes a steering motor, a first transmission mechanism, and a steering wheel body, where the first transmission mechanism is respectively connected to the steering motor and the steering wheel body, the steering motor receives the first rotation angle control quantity, and rotates according to the first rotation angle control quantity, and drives the steering wheel body to rotate through the first transmission mechanism, to change a travel direction of the to-be-controlled steering wheel.

In some embodiments, the steering wheel may further include a driving motor and a second transmission mechanism, the second transmission mechanism is respectively connected to the drive motor and the steering wheel body, the drive motor drives the steering wheel body to rotate through the second transmission mechanism, to drive the vehicle to perform translational movement, the vehicle is configured to send a rotation speed instruction to the drive motor through the CAN interface, and controls a rotation speed of the drive motor to control the magnitude of the translation speed of the vehicle. Since there are two rotation directions of the drive motor, i.e., a shaft of the driving motor rotates in two directions, the translation speed V of the steering wheel also has two directions. When the translation speed V is greater than 0, it represents that the direction of the translation speed of the steering wheel is the positive direction, and the angle between the translation speed of the steering wheel and the positive direction of the X1 axis of the preset three-dimensional coordinate system is less than 90°; when the translation speed V is less than 0, it represents that the direction of the translation speed of the steering wheel is opposite to the positive direction, and the angle between the translation speed of the steering wheel and the negative direction of the X1 axis of the preset three-dimensional coordinate system is less than 90°.

In the embodiments of the application, the first distance between the vehicle and the first track and the second distance between the vehicle and the second track are respectively detected through a distance detection sensor on the vehicle, and the offset information of the symmetrical centerline of the vehicle relative to the track centerline is determined according to the detected first distance and second distance. Since the steering wheels to be controlled at different set positions need to rotate different angles, in order to make the symmetrical centerline of the vehicle coincide with the track centerline during the travel process, the vehicle may determine, according to the offset information and position information corresponding to the to-be-controlled steering wheel, the first rotation angle control quantity of the to-be-controlled steering wheel and control, according to the first rotation angle control quantity, the to-be-controlled steering wheel to rotate to change a travel direction of the to-be-controlled steering wheel, such that during travel of the vehicle, the symmetrical centerline of the vehicle overlaps with the track centerline, thereby achieving high-precision control of the vehicle travel along the track centerline under physical track constraints. At the same time, the method provided in the embodiments of the application may be applied to determine the rotation angle control quantity of a steering wheel at any position on the vehicle chassis and has wide applicability.

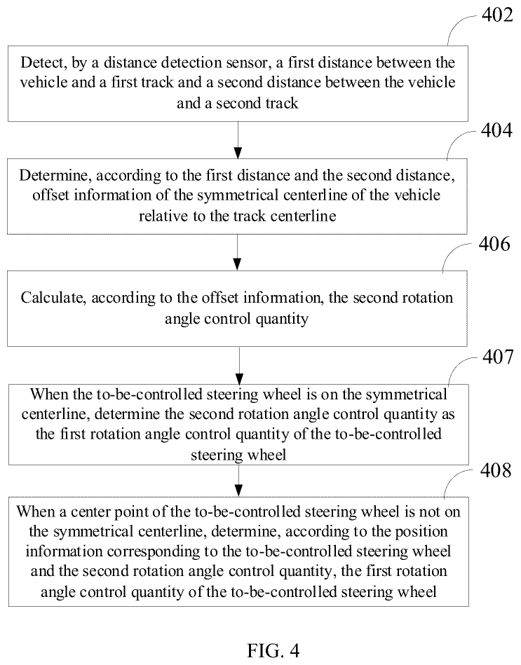

Referring to FIG. 4, which illustrates a flow diagram of another vehicle control method according to embodiments of the application, where the vehicle control method described in FIG. 4 is applicable to a vehicle.

As illustrated in FIG. 4, the method may include step 402 to step 410.

At step 402, the first distance between the vehicle and the first track and the second distance between the vehicle and the second track are detected by a distance detection sensor.

At step 404, offset information of the symmetrical centerline of the vehicle relative to the track centerline is determined according to the first distance and the second distance.

It should be noted that, the description of step 402 to step 404 may refer to the description of step 202 to step 204, which is not repeated here.

At step 406, the second rotation angle control quantity is calculated according to the offset information.

The second rotation angle control quantity corresponds to an angle that the symmetrical centerline needs to rotate. It should be noted that the offset information is used to indicate the offset degree of the symmetrical centerline of the vehicle relative to the track centerline. The vehicle may determine the angle that the symmetrical centerline needs to rotate according to the offset information to eliminate an offset of the symmetrical centerline relative to the track centerline.

In an embodiment, calculating, according to the offset information, the second rotation angle control quantity includes: determining a first angle corresponding to a second ratio, and determining, according to the first angle and the deflection steering angle, the second rotation angle control quantity. The second ratio is a ratio of the distance vector of the target point A to the preset convergence parameter. It should be noted that, using the vehicle control method provided in the embodiments can make the offset degree between the symmetrical centerline of the vehicle and the track centerline to approach 0, i.e., can make the deflection steering angle θ to approach 0, and make the distance vector e between the target point A on the symmetrical centerline and the track centerline to approach 0. The preset convergence parameter is related to the response speed and convergence time of the vehicle, i.e., the preset convergence parameter affects the response speed and convergence time of the vehicle. The response speed of the vehicle includes the time required for an absolute value of the distance vector e to be less than 1% of the absolute value of the initial distance vector for the first time, and the time required for an absolute value of the deflection steering angle θ to be less than 1% of the absolute value of the initial deflection steering angle for the first time. The convergence time of the vehicle includes the time required for the absolute value of the distance vector e to be greater than 1% of the absolute value of the initial distance vector for the last time, and the time required for the absolute value of the deflection steering angle θ to be greater than 1% of the absolute value of the initial deflection steering angle for the last time. The range of the preset convergence parameter includes (0, +∞). In some embodiments, the preset convergence parameter is 0.1, 1, or 10. By choosing an appropriate preset convergence parameter, the response speed and convergence time of the vehicle may be adjusted. The response speed of the vehicle is positively correlated with the preset convergence parameter, and the convergence time of the vehicle is positively correlated with the preset convergence parameter. In some embodiments, the first angle corresponding to the second ratio is the arctangent value of the second ratio.

In an embodiment, determining, according to the first angle and the deflection steering angle, the second rotation angle control quantity of the vehicle may include: when the travel direction of the vehicle is the forward direction, calculating a first difference value between an opposite number of the deflection steering angle and the first angle, and determining the first difference value as the second rotation angle control quantity of the vehicle; when the travel direction of the vehicle is the backward direction, calculating a second difference value between the deflection steering angle and the first angle, and determining the second difference value as the second rotation angle control quantity of the vehicle. It should be noted that, the forward travel and backward travel of the vehicle are also controlled by the rotation angle control quantities of respective steering wheels. The vehicle may determine the travel direction of the vehicle according to environmental conditions, task requirements, etc. Determining the second rotation angle control quantity in different ways according to the travel direction of the vehicle may improve the accuracy of the determined second rotation angle control quantity.

In an embodiment, for the vehicle, when the translation speed V>0, the calculation method of the second rotation angle corresponding to the second rotation angle control quantity may refer to the following calculation formula (1):

$$ϕ 2 = - θ - {tan}^{- 1} ( \frac{e}{K} ) , \qquad ( 1 )$$

where, ϕ2 represents the second rotation angle corresponding to the second rotation angle control quantity; θ represents the deflection steering angle of the target point; e represents the distance vector from the target point on the symmetrical centerline to the track centerline; K represents the preset convergence parameter. When the translation speed of the vehicle V<0, the calculation method of the second rotation angle corresponding to the second rotation angle control quantity can refer to the following calculation formula (2):

$$ϕ 2 = θ - {tan}^{- 1} ( \frac{e}{K} ) , \qquad ( 2 )$$

where, ϕ2 represents the second rotation angle corresponding to the second rotation angle control quantity; θ represents the deflection steering angle of the target point; e represents the distance vector from the target point on the symmetrical centerline to the track centerline; K represents the preset convergence parameter. Referring to FIG. 3B, the second rotation angle ¢2 corresponding to the second rotation angle control quantity illustrated in FIG. 3B is in a positive direction, i.e., a direction in which the positive direction of the X1 axis turns to the positive direction of the Y1 axis is the positive direction, and a range of the second rotation angle ϕ2 is (−π/2, π/2). V represents the translation speed of the vehicle, when the translation speed V is greater than 0, the travel direction of the vehicle is a forward direction, when the translation speed V is less than 0, the travel direction of the vehicle is a backward direction. K is the preset convergence parameter, and the range of K is (0, +∞), e represents the distance vector, i.e., the coordinate value corresponding to the target point A on the Y1 axis, and θ represents the deflection steering angle. It should be noted that when the translation speed V is greater than 0, the vehicle travels in the positive direction of the X1 axis, and when the translation speed V is less than 0, the vehicle travels in the negative direction of the X1 axis.

At step 407, when the to-be-controlled steering wheel is on the symmetrical centerline, the second rotation angle control quantity is determined as the first rotation angle control quantity of the to-be-controlled steering wheel.

It should be noted that, since the second rotation angle control quantity is the angle that the symmetrical centerline needs to rotate around the rotation center to the track centerline, if the to-be-controlled steering wheel is set on the symmetrical centerline of the vehicle, then the angle that the to-be-controlled steering wheel needs to rotate should be consistent with the angle that the symmetrical centerline needs to rotate around the rotation center to the track centerline, such that the symmetrical centerline of the vehicle overlaps with the track centerline after the vehicle has traveled for a certain period of time. When the to-be-controlled steering wheel is set on the symmetrical centerline, the vehicle determines the second rotation angle control quantity as the first rotation angle control quantity of the to-be-controlled steering wheel, which may make the symmetrical centerline of the vehicle restore to overlap with the track centerline after the vehicle has traveled for a certain period of time. It may be understood that this certain period of time is related to the magnitude of the preset convergence parameter.

At step 408, when the center point of the to-be-controlled steering wheel is not on the symmetrical centerline, according to the position information corresponding to the to-be-controlled steering wheel and the second rotation angle control quantity, the first rotation angle control quantity of the to-be-controlled steering wheel is determined.

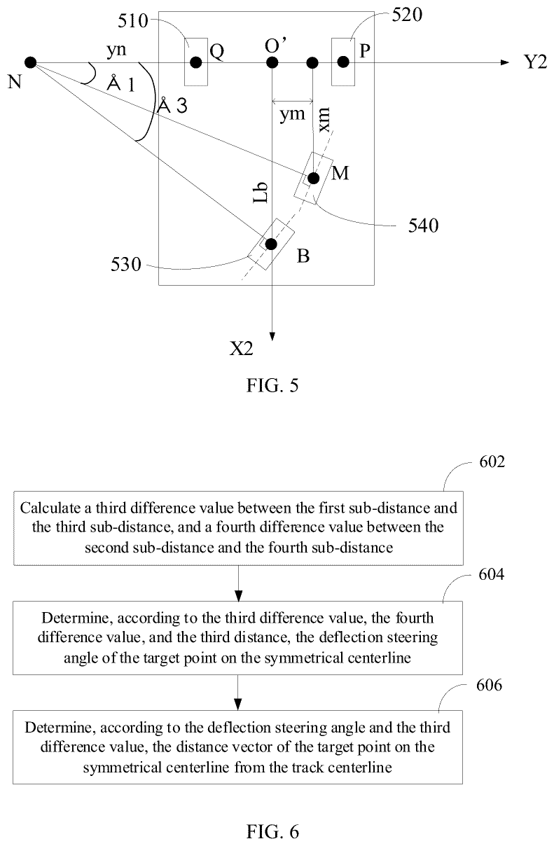

As illustrated in FIG. 5, the vehicle further includes two directional wheels, for case of description, the two directional wheels are respectively called the first directional wheel 510 and the second directional wheel 520, the center point of the first directional wheel 510 is point Q, the center point of the second directional wheel 520 is point P, the line connecting the centers of the two directional wheels may be understood as the center point connection line between the two directional wheels, i.e., the line connecting point Q and point P. The line connecting the centers of the two directional wheels is perpendicular to the symmetrical centerline of the vehicle. The position information of the to-be-controlled steering wheel may include the coordinate information of the center points of the to-be-controlled steering wheels in the preset planar coordinate system, where, the first axis X2 direction of the preset planar coordinate system is parallel to the symmetrical centerline of the vehicle, the second axis Y2 direction of the preset planar coordinate system is perpendicular to the symmetrical centerline of the vehicle, and the origin O′ of the preset planar coordinate system is the midpoint of the line connecting the centers of the two directional wheels. It should be noted that, the to-be-controlled steering wheel may be set at any position on the vehicle chassis, and the vehicle may store in advance the coordinate information of the center point of each to-be-controlled steering wheel in the preset planar coordinate system. The center point of the to-be-controlled steering wheel may be understood as the intersection point of the to-be-controlled steering wheel and the vehicle traveling road surface. Continuing to refer to FIG. 5, the preset planar coordinate system conforms to Cartesian right-hand coordinate system rule. When the vehicle travels normally, each mass point on the vehicle rotates around the rotation center N of the vehicle. The rotation center N of the vehicle is collinear with the center points of the two directional wheels. The coordinate information of the to-be-controlled steering wheel in the preset planar coordinate system is determined as the position information corresponding to the to-be-controlled steering wheel. When the second rotation angle control quantity is obtained, the first rotation angle control quantity may be obtained according to the conversion relationship between the second rotation angle corresponding to the second rotation angle control quantity and the first rotation angle corresponding to the first rotation angle control quantity. In the embodiment, the first rotation angle control quantity of any steering wheel on the vehicle chassis may be obtained by directly using the coordinate information of the to-be-controlled steering wheel in the preset planar coordinate system and the second rotation angle control quantity, which has a wide range of applicability and may improve the calculation speed of the first rotation angle control quantity of the vehicle.

In an embodiment, the coordinate information of the to-be-controlled steering wheel in the preset planar coordinate system may include the corresponding first coordinate value of the to-be-controlled steering wheel in the first axis X2 direction, and the second coordinate value corresponding to the to-be-controlled steering wheel in the second axis Y2 direction. Determining the first rotation angle control quantity of the to-be-controlled steering wheel according to the position information corresponding to the to-be-controlled steering wheel and the second rotation angle control quantity may include: calculating the first ratio of the first coordinate value of the to-be-controlled steering wheel to the target value, and determining the first rotation angle control quantity according to the first ratio. The target value is the sum of the second coordinate value and a product of the corresponding first coordinate value of the to-be-controlled steering wheel on the symmetrical centerline in the first axis X2 direction and a reciprocal of the tangent value of the second rotation angle control quantity. In some embodiments, determining the first rotation angle control quantity according to the first ratio may include: determining the first rotation angle corresponding to the first rotation angle control quantity according to the arctangent value of the first ratio. In the embodiment, by calculating the first ratio of the first coordinate value to the target value, and determining, according to the first ratio, the first rotation angle, the first rotation angle control quantity is determined. The calculation method of the first rotation angle provided in the embodiment is simple, which improves the speed at which the vehicle determines the first rotation angle.

In an embodiment, the second coordinate value of the to-be-controlled steering wheel 540 in the preset planar coordinate system is not 0, and the first coordinate value is greater than 0. In this case, the calculation formula (3) for the first rotation angle ϕ1 corresponding to the first rotation angle control quantity of the to-be-controlled steering wheel 540 is as follows:

$$ϕ 1 = {tan}^{- 1} ( \frac{x m}{\frac{Lb}{tan ( ϕ 2 )} - ym} ) , \qquad ( 3 )$$

where, xm represents the first coordinate value of the center point M of the to-be-controlled steering wheel in the preset planar coordinate system, ym represents the second coordinate value of the center point M of the to-be-controlled steering wheel in the preset planar coordinate system, ϕ1 represents the first rotation angle corresponding to the first rotation angle control quantity of the to-be-controlled steering wheel 540, 2 represents the second rotation angle corresponding to the second rotation angle control quantity, and Lb represents the abscissa value of the center point B of the steering wheel 530 in the preset planar coordinate system. It should be noted that, continuing to refer to FIG. 5, the rotation center N of the vehicle in the preset planar coordinate system is (xn, yn), the center point M of the to-be-controlled steering wheel 540 in the preset planar coordinate system is (xm, ym), it is assumed that there is a first steering wheel 530 on the symmetrical centerline of the vehicle, the vehicle may have a first steering wheel 530, and may not have the first steering wheel 530. The center point B of the first steering wheel 530 in the preset planar coordinate system is (Lb, 0), where N is on the extension line of PQ, line segment BN is perpendicular to the travel direction of the first steering wheel 530, line segment MN is perpendicular to the travel direction of the to-be-controlled steering wheel 540, and a relational expression (4) and a relational expression (5) may be obtained:

$$tan ( ϕ 2 ) = sign ( ϕ 2 ) * {O}^{′} B / {O}^{′} N = Lb / ( yn ) , \qquad ( 4 )$$

$$tan ( ϕ 1 ) = xm / ( yn - ym ) . \qquad ( 5 )$$

In the embodiment of the application, combining relational expression (4) and relational expression (5) may obtain the calculation formula (3) for the first rotation angle ϕ1 corresponding to the first rotation angle control quantity of the to-be-controlled steering wheel 540.

In an embodiment, the second coordinate value of the center point M of the to-be-controlled steering wheel in the preset planar coordinate system is not 0, and the first coordinate value is less than 0. In this case, the calculation formula (6) for the first rotation angle ϕ1 corresponding to the first rotation angle control quantity of the to-be-controlled steering wheel is as follows:

$$ϕ 1 = {tan}^{- 1} ( \frac{- x m}{\frac{Lb}{tan ( ϕ 2 )} - ym} ) . \qquad ( 6 )$$

At step 410, according to the first rotation angle control quantity, the to-be-controlled steering wheel is controlled to rotate to change a travel direction of the to-be-controlled steering wheel, such that during travel of the vehicle, the symmetrical centerline of the vehicle overlaps with the track centerline.

The description of step 410 may refer to the description of step 208, which is not repeated here.

In the embodiment, by storing in advance the coordinate information of the to-be-controlled steering wheel in the preset coordinate system in the vehicle, and when the second rotation angle control quantity is determined, directly using the first coordinate value and the second coordinate value to calculate the first rotation angle control quantity, a method for determining the rotation angle control quantity of any steering wheel of the vehicle is provided, which achieves high-precision control of the vehicle in the track centerline, and at the same time reduces the calculation amount of the vehicle for determining the rotation angle control quantity

Referring to FIG. 6, which illustrates a flow diagram for determining offset information according to embodiments of the application. As illustrated in FIG. 6, determining the offset information of the symmetrical centerline of the vehicle relative to the track centerline according to the first distance and the second distance may include step 602 to step 606.

At step 602, a third difference value between the first sub-distance and the third sub-distance is calculated, and a fourth difference value between the second sub-distance and the fourth sub-distance is calculated.

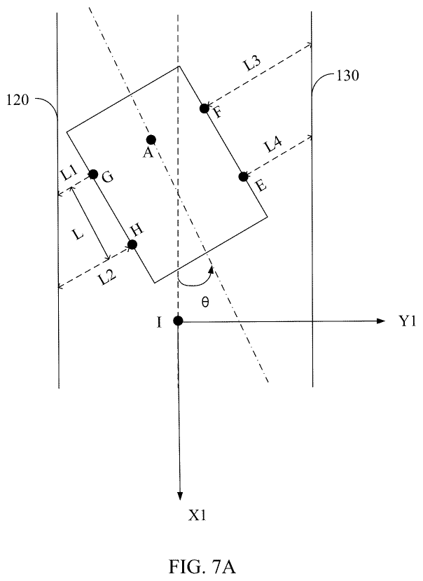

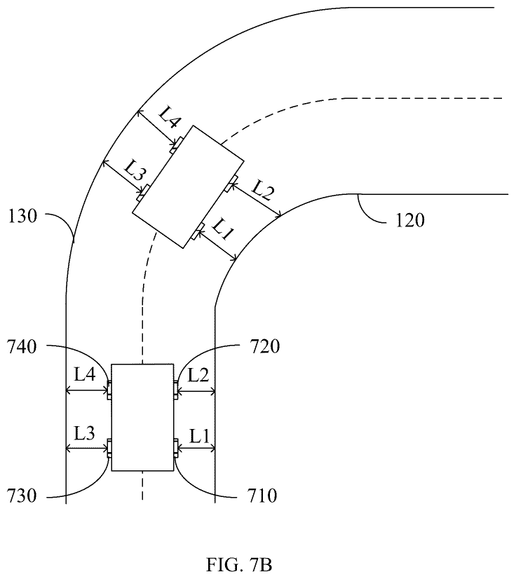

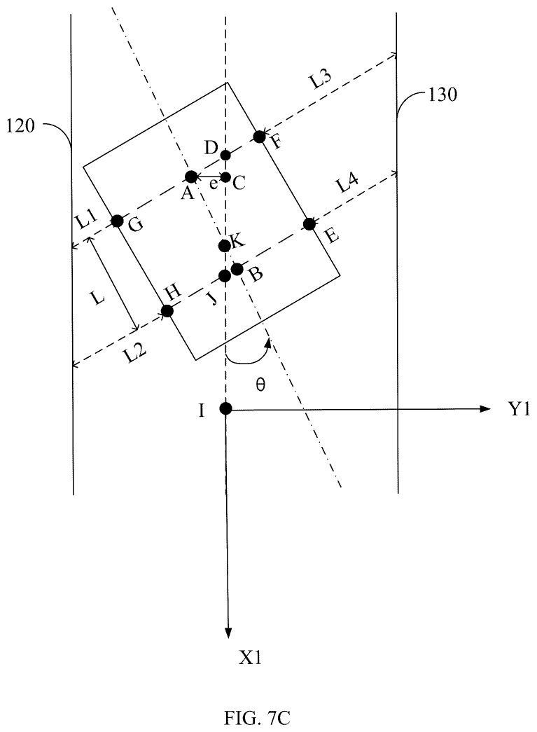

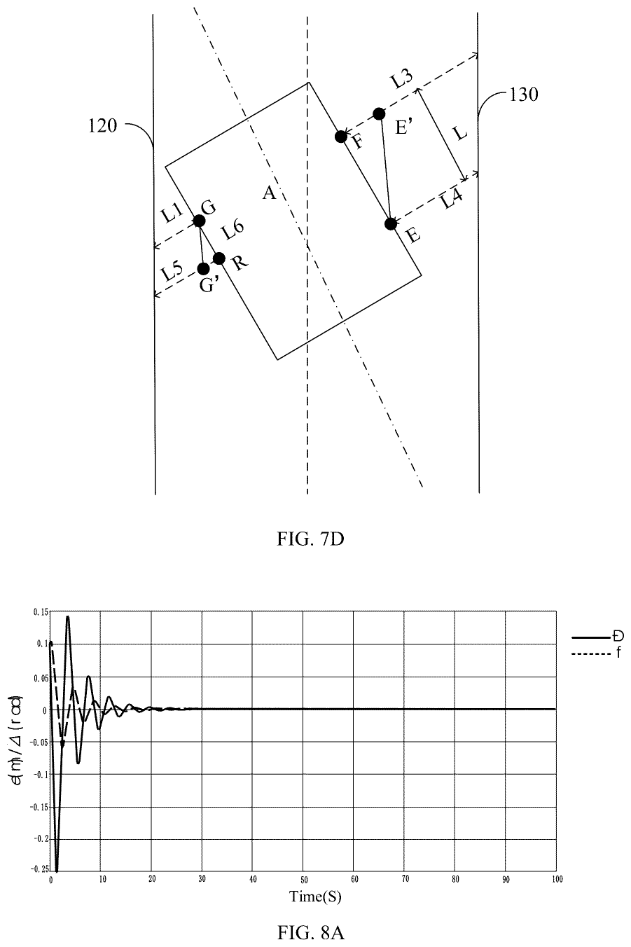

It should be noted that, referring to FIG. 7A, the first distance may include the first sub-distance L1 from the first position G of the vehicle along the width direction of the vehicle to the first track 120, as well as the second sub-distance L2 from the second position H of the vehicle along the width direction of the vehicle to the first track 120. The second distance includes the third sub-distance L3 from the third position F of the vehicle along the width direction of the vehicle to the second track 130, and the fourth sub-distance L4 from the fourth position E of the vehicle along the width direction of the vehicle to the second track 130. The line connecting the first position G and the third position F, the line connecting the second position H and the fourth position E, and the width direction of the vehicle are all perpendicular to the symmetrical centerline of the vehicle. The position relationship of the symmetrical centerline of the vehicle relative to the first track 120 may be determined through the first sub-distance L1 and the second sub-distance L2. The position relationship of the symmetrical centerline of the vehicle relative to the second track 130 may be determined through the third sub-distance L3 and the fourth sub-distance L4. And since the first track 120 and the second track 130 are axisymmetric with respect to the track centerline, the offset information of the symmetrical centerline of the vehicle relative to the track centerline may be determined by detecting the first sub-distance L1, the second sub-distance L2, the third sub-distance L3, and the fourth sub-distance L4. In some embodiments, the first position G and the second position H are on the first side surface of the vehicle, while the third position F and the fourth position E are on the second side surface of the vehicle, where the first side is opposite to the second side. By calculating the third difference value between the first sub-distance and third sub-distance, as well as the fourth difference value between the second sub-distance and fourth sub-distance, the vehicle may determine the offset distances respectively from two different positions on the symmetrical centerline of the vehicle to the track centerline.

In an embodiment, as illustrated in FIG. 7B, the distance detection sensor may include a first laser rangefinder 710, a second laser rangefinder 720, a third laser rangefinder 730, and a fourth laser rangefinder 740, where the first laser rangefinder 710 is installed at the first position G and perpendicular to the first side surface of the vehicle, the second laser rangefinder 720 is installed at the second position H and perpendicular to the first side surface of the vehicle, the third laser rangefinder 730 is installed at the third position F and perpendicular to the second side surface of the vehicle, and the fourth laser rangefinder 740 is installed at the fourth position E and perpendicular to the second side surface of the vehicle. The four laser rangefinders emit light rays perpendicular to the symmetrical centerline of the vehicle, where the first laser rangefinder 710 is configured to detect the first sub-distance L1, the second laser rangefinder 720 is configured to detect the second sub-distance L2, the third laser rangefinder 730 is configured to detect the third sub-distance L3, and the fourth laser rangefinder 740 is configured to detect the fourth sub-distance L4. In some embodiments, the installation height of the laser rangefinder is less than the height of the first track and the height of the second track, such that when the laser rangefinder is vertically installed on the vehicle, the light ray emitted by the laser rangefinder may be projected onto the first track or the second track. In some embodiments, the measurement range of the laser rangefinder is 0.05 m to 12 m, which meets the distance measurement requirements of the vehicle traveling between the first track 120 and the second track 130. In the embodiment, by setting at least four laser rangefinders on the vehicle to collect the first sub-distance L1, the second sub-distance L2, the third sub-distance L3, and the fourth sub-distance L4 in real time, and directly using the detected distances (the first sub-distance L1, the second sub-distance L2, the third sub-distance L3, and the fourth sub-distance L4) to calculate the first rotation angle control quantity of the to-be-controlled steering wheel in real time, the calculation amount of the vehicle may be reduced, and the determination speed of the first rotation angle control quantity can be improved.

It may be understood that, in addition to the first laser rangefinder 710, the second laser rangefinder 720, the third laser rangefinder 730, and the fourth laser rangefinder 740, the distance detection sensors may further include other laser rangefinders. When any one of the first laser rangefinder 710, the second laser rangefinder 720, the third laser rangefinder 730, and the fourth laser rangefinder 740 is damaged, e.g., the first laser rangefinder 710 is damaged, the distance detected by the other laser rangefinder set on the first side surface may be converted into the first sub-distance L1 to ensure the reliability of the vehicle control method. For example, referring to FIG. 7D, the distance detection sensor may further include a fifth laser rangefinder, which is installed at the fifth position R and perpendicular to the first side surface, and the fifth position R is a position on the first side surface of the vehicle. According to FIG. 7D, it may be easily seen that ΔGRG′ and ΔEFE′ are similar triangles. The third laser rangefinder 730 detects and obtains the third sub-distance L3, and the fourth laser rangefinder 740 detects and obtains the fourth sub-distance L4. The sixth difference value E′F between the third sub-distance L3 and the fourth sub-distance L4 is calculated, and the sixth distance L6 between the fifth position R and the first position G in the direction of the symmetrical centerline of the vehicle is determined, and the distance L between the third position E and the fourth position F in the symmetrical centerline direction of the vehicle is determined. According to the ratio of the sixth distance L6 to the distance L, the sixth difference E′F, and the fifth sub-distance L5 detected by the fifth laser rangefinder, the first sub-distance L1 may be converted and obtained. Specifically, L1=L5−G′R, G′R=[(L3−L4)*L6]/L.

At step 604, the deflection steering angle of the target point on the symmetrical centerline is determined according to the third difference value between the first sub-distance and the third sub-distance, the fourth difference value between the second sub-distance and the fourth sub-distance and the third distance.

Continuing to refer to FIG. 7A, the third difference value is the difference value between the first sub-distance L1 and the third sub-distance L3, and the fourth difference value is the difference value between the second sub-distance L2 and the fourth sub-distance L4, the third distance L is the distance between the second position H and the first position G in the symmetrical centerline direction of the vehicle, i.e., the third distance L is the distance between the second position H and the first position G in the symmetrical centerline direction. It should be noted that, the descriptions of the first sub-distance L1, the second sub-distance L2, the third sub-distance L3, and the fourth sub-distance L4 refer to the above embodiments, which are not repeated here.

In an embodiment, the calculation method of the deflection steering angle θ may refer to the following calculation formula (7):

$$θ = {tan}^{- 1} [ ( \frac{L 2 - L 4}{2} - \frac{L 1 - L 3}{2} ) / L ] , \qquad ( 7 )$$

where, L1 represents the first sub-distance, L2 represents the second sub-distance, L3 represents the third sub-distance, L4 represents the fourth sub-distance, and L represents the distance between the second position H and the first position G in the symmetrical centerline direction of the vehicle.

At step 606, the distance vector of the target point on the symmetrical centerline from the track centerline is determined according to the deflection steering angle and the third difference value.

The target point A is the intersection point between the line connecting the first position G and the third position F and the symmetrical centerline of the vehicle. In some embodiments, the calculation method of the distance vector e may refer to the following calculation formula (8):

$$e = \frac{L 1 - L 3}{2} * cos θ , \qquad ( 8 )$$

where, θ represents the deflection steering angle, L1 represents the first sub-distance, L3 represents the third sub-distance.

The calculation formula (7) for the deflection steering angle θ and the calculation formula (8) for the distance vector e are proved as follows.

Referring to FIG. 7C, where point G, point H, point F, and point E respectively represent the first position G, the second position H, the third position F, and the fourth position E, point J is the intersection point of line segment EH and the track centerline, point K is the intersection point of the track centerline and the symmetrical centerline, point B is the intersection point of line segment EH and the symmetrical centerline of the vehicle, point D is the intersection point of line segment GF and the track centerline, the length of line segment AB is L, line segment AC is perpendicular to the track centerline, and point C is the perpendicular foot, line segment AB is respectively perpendicular to EH and FG, and points EFGH form a rectangle.

Due to symmetry, equations (9) and (10) may be obtained,

$$L 1 + A G + A D = L 3 + A F - AD , \qquad ( 9 )$$

$$AG = AF . \qquad ( 10 )$$

Combining equations (9) and (10) may obtain equation (11),

$$2 A D = L 3 - L 1. \qquad ( 11 )$$

Similarly, equation (12) may be obtained,

$$2 B J = L 2 - L 4. \qquad ( 12 )$$

In right triangle ADC and right triangle ADK, equations (13) and (14) may be obtained,

$$∠ DAC = ∠ AKD = θ , \qquad ( 13 )$$

$$tan θ = AD / AK = BJ / BK . \qquad ( 14 )$$

Equation (15) may be obtained from a proportional formula,

$$tan θ = ( A D + BJ ) / ( AK + B K ) = ( \frac{L 2 - L 4}{2} - \frac{L 1 - L 3}{2} ) / L . \qquad ( 15 )$$

From this, the calculation formula (7) for the deflection steering angle θ may be obtained.

In addition, in right triangle ADC, equation (16) may be easily obtained,

$$A C = AD * cos ( θ ) . \qquad ( 16 )$$

From this, the calculation formula (8) for the distance vector e may be obtained.

The following demonstrates the accuracy of the vehicle control method provided in the embodiment. The coordinates of the target point A in the preset three-dimensional coordinate system are (x, e), where Z1 axis is omitted. According to the plane rigid body motion theorem, the calculation formula (17) for the translation speed ė of the target point A, and the calculation formula (18) for the angular speed ė may be obtained,

$$\dot{e} = V * cos ( ϕ 2 ) * sin θ , \qquad ( 17 )$$

$$\dot{θ} = V * \frac{sin ϕ2}{L} . \qquad ( 18 )$$

As illustrated in FIG. 7C, L is the distance between the second position H and the first position G in the symmetrical centerline direction of the vehicle. Substituting formula (1) and formula (2) into formula (17) and formula (18) respectively to replace ϕ2 may obtain the following equation set:
when the translation speed V>0,

$$\dot{e} = V * cos [ - θ - {tan}^{- 1} ( \frac{e}{K} ) ] * sin θ , \qquad ( 19 )$$

$$\dot{θ} = V * sin [ - θ - {tan}^{- 1} ( \frac{e}{K} ) ] / L , \qquad ( 20 )$$

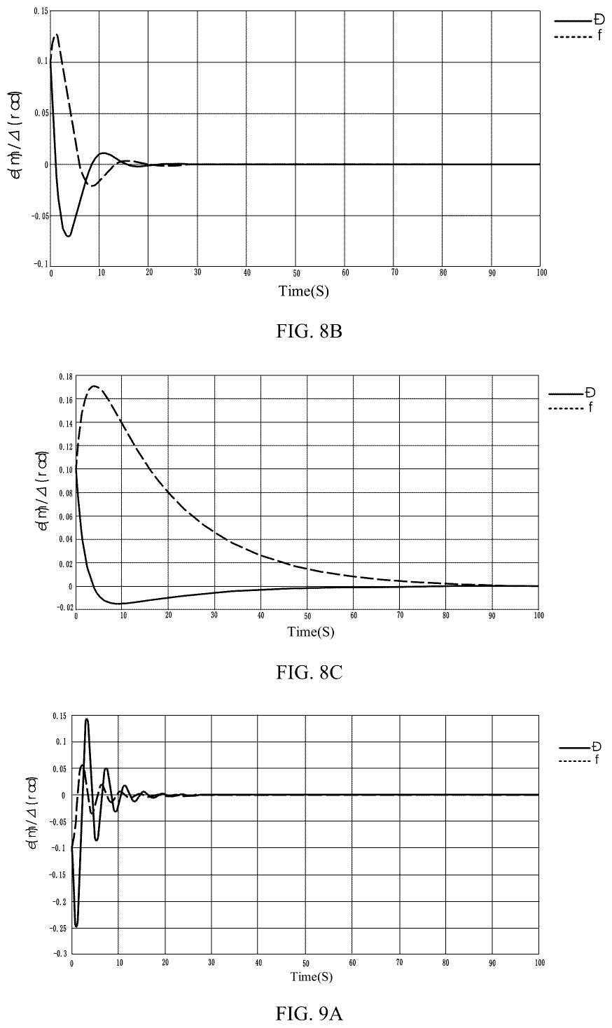

when the translation speed V<0,

$$\dot{e} = V * cos [ θ - {tan}^{- 1} ( \frac{e}{K} ) ] * sin θ , \qquad ( 21 )$$

$$\dot{θ} = V * sin [ θ - {tan}^{- 1} ( \frac{e}{K} ) ] / L , \qquad ( 22 )$$

where ė represents the translation speed of the target point A, which is the derivative of the distance vector e, \dot{θ} represents the angular velocity of the target point A, which is the derivative of the deflection steering angle θ. The above equation set is a nonlinear differential equation system, which may be solved by using the standard mode of the 4th-order Runge-Kutta method, which obtains the numerical solution by approximating the differential equation within a certain step size. The calculation formulas are as follows, let:

$$\dot{y} = f ( t , y ) , \qquad ( 23 )$$

$$f ( t 0 , y 0 ) = \dot{y} 0 , \qquad ( 24 )$$

where, f(t, y) is the given function to be solved, y0 is the initial condition, then the iterative formula is as follows:

$${y}_{i + 1} = {y}_{i} + ( K 1 + 2 K 2 + 2 K 3 + K 4 ) / 6 , \qquad ( 25 )$$

$$K 1 = f ( {t}_{i} , {y}_{i} ) , \qquad ( 26 )$$

$$K 2 = f ( {t}_{i} + h / 2 , {y}_{i} + K 1 / 2 ) , \qquad ( 27 )$$

$$K 3 = f ( {t}_{i} + h / 2 , {y}_{i} + K 2 / 2 ) , \qquad ( 28 )$$

$$K 4 = f ( {t}_{i} + h , {y}_{i} + K 3 ) , \qquad ( 29 )$$

where, h represents the step size, K1 represents the slope of the first point, K2 represents the slope of the second point calculated according to K1, K3 represents the slope of the third point calculated according to K2, K4 is the slope of the fourth point calculated according to K3, and yᵢ₊₁ is the next value of yᵢ. The numerical solution to this equation is found. For the case where the translation speed V is greater than 0, let the step size h be 0.001 m, let V=0.5 m/s, and the preset convergence parameters K is 0.1, 1, and 10 respectively, and the initial conditions being e1=0.1 and θ1-0.1, the solving of the numerical solution of the equation set is illustrated in FIG. 8A to FIG. 8C, where the preset convergence parameter K in FIG. 8A is 0.1, the preset convergence parameter K in FIG. 8b is 1, and the preset convergence parameter K in FIG. 8C is 10. According to FIG. 8A to FIG. 8B, it may be easily obtained that the method provided in the embodiment may enable the deflection steering angle θ of the target point on the centerline of the vehicle tend to approach 0, and the distance vector e of the target point tend to approach 0, i.e., which may make the symmetrical centerline of the vehicle overlap with the track centerline. According to FIG. 8A to FIG. 8B, it may be easily obtained that the preset convergence parameter is positively correlated with the response speed of the vehicle, and the preset convergence parameter is positively correlated with the convergence time of the vehicle.

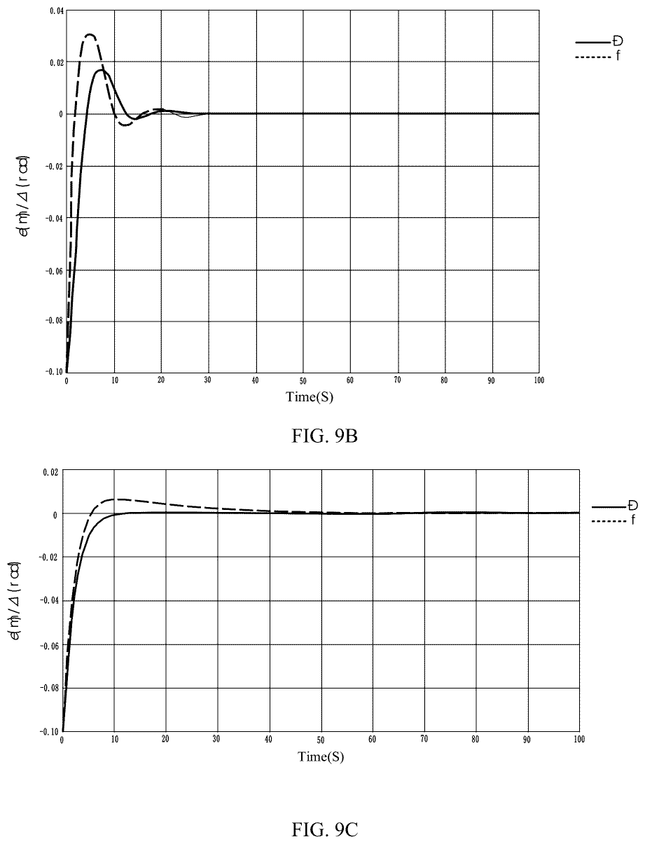

For the case where the translation speed V is less than 0, let the step size h be 0.001, let V=−0.5 m/s, K is 0.1, 1, and 10 respectively, and the initial conditions are e2=−0.1 and θ2=−0.1, the solving of the numerical solution of the equation set is illustrated in FIG. 9A to FIG. 9C, where the preset convergence parameter in FIG. 9A is 0.1, the preset convergence parameter in FIG. 9B is 1, and the preset convergence parameter in FIG. 9C is 10. According to FIGS. 9A to 9B, it may be obtained that the method provided in the embodiment may make the θ tend to approach 0, Y-axis coordinate component e of point A tend to approach 0. According to FIGS. 9A to 9B, it may be obtained that the method provided in the embodiment may make the deflection steering angle θ of the target point on the centerline of the vehicle tend to approach 0, the distance vector e of the target point tend to approach 0, i.e., make the symmetrical centerline of the vehicle overlap with the track centerline. And according to FIGS. 9A to 9C, it may be easily obtained that the preset convergence parameter is positively correlated with response speed of the vehicle, and the preset convergence parameter is positively correlated with the convergence time of the vehicle.

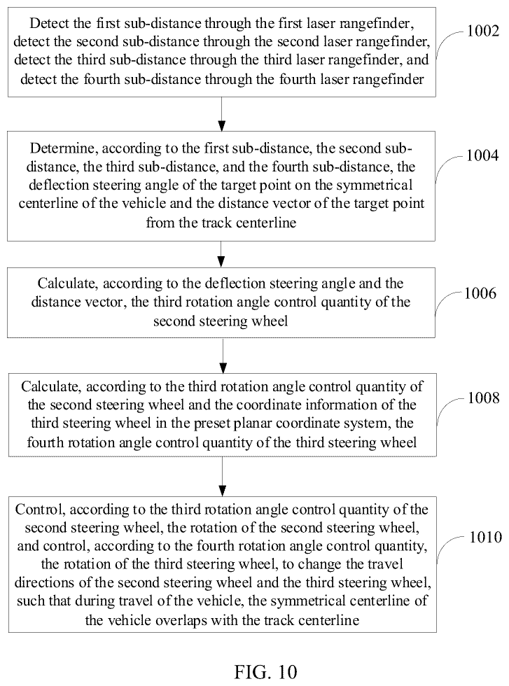

Referring to FIG. 10, which shows a flow chart of another vehicle control method provided in this embodiment of the application, where the vehicle control method described in FIG. 10 is applicable to the vehicle. The vehicle may include a third directional wheel, a fourth directional wheel, a second steering wheel, and a third steering wheel, where the center point of the second steering wheel is on the symmetrical centerline of the vehicle, and the center point of the third steering wheel is not on the symmetrical centerline of the vehicle.

As illustrated in FIG. 10, the vehicle control method may include step 1002 to step 1010.

At step 1002, the first sub-distance is detected through the first laser rangefinder, the second sub-distance is detected through the second laser rangefinder, the third sub-distance is detected through the third laser rangefinder, and the fourth sub-distance is detected through the fourth laser rangefinder.

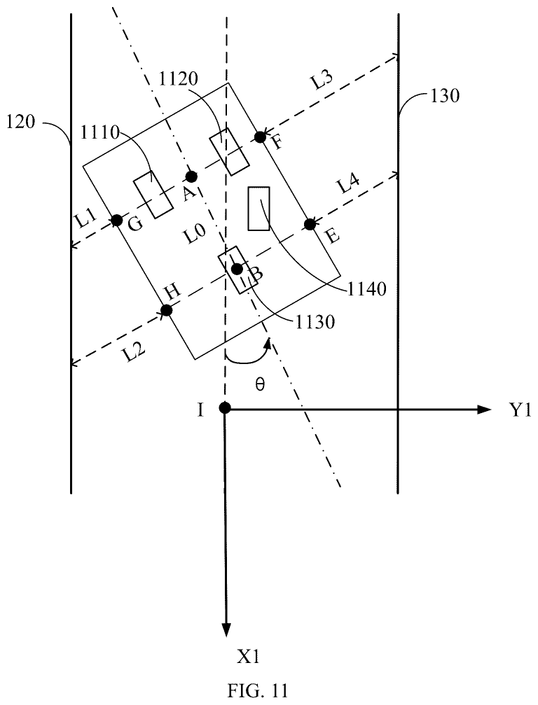

It should be noted that, referring to FIG. 11, the first position G, the third position F, the center point of the third directional wheel 1110, and the center point of the fourth directional wheel 1120 are collinear, the second position H, the fourth position E, and the center point of the second steering wheel 1130 are collinear, and the center point of the second steering wheel 1130 overlaps with the intersection point B between the line segment EH and the symmetrical centerline, and the third steering wheel 1140 is set at any position on the vehicle chassis. The first laser rangefinder and the second laser rangefinder are vertically installed on the first side surface of the vehicle, and the emission light rays of the first laser rangefinder and second laser rangefinder are perpendicular to the first side surface of the vehicle and towards the first track 120. The third laser rangefinder and fourth laser rangefinder are vertically installed on the second side surface of the vehicle, and the emission light rays of the third laser rangefinder and fourth laser rangefinder are perpendicular to the second side of the vehicle and towards the second track 130. The first sub-distance L/is collected through the first laser rangefinder, the second sub-distance L2 is collected through the second laser rangefinder, the third sub-distance L3 is collected through the third laser rangefinder, and the fourth sub-distance L4 is collected through the fourth laser rangefinder.

At step 1004, the deflection steering angle of the target point on the symmetrical centerline of the vehicle and the distance vector of the target point from the track centerline are determined according to the first sub-distance, the second sub-distance, the third sub-distance, and the fourth sub-distance.

The target point A is the intersection point between the symmetrical centerline of the vehicle and the line connecting the center point of the third directional wheel 1110 and the center point of the fourth directional wheel 1120. The calculation formula of the distance vector e may refer to the calculation formula (8) in the above embodiments, and the calculation formula (30) for the deflection steering angle θ is as follows:

$$θ = {tan}^{- 1} [ ( \frac{L 2 - L 4}{2} - \frac{L 1 - L 3}{2} ) / L 0 ] , \qquad ( 30 )$$

where L1 represents the first sub-distance, L2 represents the second sub-distance, L3 represents the third sub-distance, L4 represents the fourth sub-distance, L0 represents the axle length of the vehicle, i.e., the distance between the target point A and the center point of the second steering wheel 1130.

At step 1006, the third rotation angle control quantity of the second steering wheel is calculated according to the deflection steering angle and the distance vector.

It should be noted that, the vehicle may, according to the deflection steering angle of the target point on the symmetrical centerline and the distance vector of the target point from the track centerline, first calculate the third rotation angle that the second steering wheel 1130 needs to rotate, and then determine the third rotation angle control quantity of the second steering wheel according to the third rotation angle that the second steering wheel needs to rotate. The calculation formula for the third rotation angle corresponding to the third rotation angle control quantity of the second steering wheel may refer to the calculation formula (1) and the calculation formula (2).

At step 1008, the fourth rotation angle control quantity of the third steering wheel is calculated according to the third rotation angle control quantity of the second steering wheel and the coordinate information of the third steering wheel in the preset planar coordinate system.

It should be noted that, in a case where the first coordinate value of the third steering wheel 1140 is greater than 0, the calculation method of the fourth rotation angle corresponding to the fourth rotation angle control quantity of the third steering wheel 1140 may refer to the calculation formula (3).

At step 1010, the second steering wheel is controlled to rotate according to the third rotation angle control quantity of the second steering wheel, and the third steering wheel is controlled to rotate according to the fourth rotation angle control quantity, to change the travel directions of the second steering wheel and the third steering wheel, such that during travel of the vehicle, the symmetrical centerline of the vehicle overlaps with the track centerline.

In the embodiment, by providing four laser rangefinders on the vehicle to respectively collect the first sub-distance, the second sub-distance, the third sub-distance, and the fourth sub-distance, and directly using the first sub-distance, the second sub-distance, the third sub-distance, and the fourth sub-distance to calculate the third rotation angle control quantity of the second steering wheel, and determining the fourth rotation angle control quantity of the third steering wheel according to the third rotation angle control quantity of the second steering wheel and the coordinate information of the third steering wheel in the preset planar coordinate system, and respectively controlling the second steering wheel and the third steering wheel to rotate according to the third rotation angle control quantity and the fourth rotation angle control quantity, which achieves high-precision control of the travel of the vehicle along the track centerline.

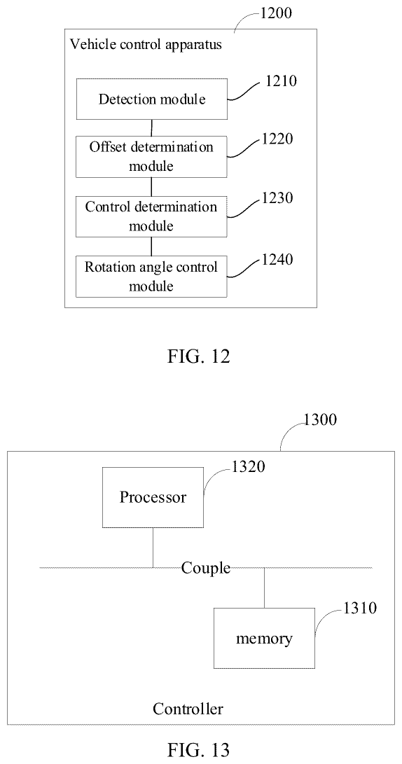

Referring to FIG. 12, which illustrates a structure diagram of a vehicle control apparatus according to an embodiment of the application. The apparatus may be applied to a vehicle. As illustrated in FIG. 12, the vehicle control apparatus 1200 may include a detection module 1210, an offset determination module 1220, a control determination module 1230, and a rotation angle control module 1240. The detection module 1210 is configured to determine the first distance between the vehicle and the first track, and to detect the second distance between the vehicle and the second track. The offset determination module 1220 is configured to determine the offset information of the symmetrical centerline of the vehicle relative to the track centerline according to the first distance and the second distance. The first track and the second track are axisymmetric with respect to the track centerline. The control determination module 1230 is configured to determine the first rotation angle control quantity of the to-be-controlled steering wheel according to the position information corresponding to the to-be-controlled steering wheel and the offset information. The position information corresponding to the to-be-controlled steering wheel is configured to indicate a set position of the to-be-controlled steering wheel on the vehicle, and the to-be-controlled steering wheel is any one of at least one steering wheel. The rotation angle control module 1240 is configured to control the to-be-controlled steering wheel to rotate according to the first rotation angle control quantity, to change the travel direction of the to-be-controlled steering wheel, such that during the travel process of the vehicle, the symmetrical centerline of the vehicle overlaps with the track centerline.

The embodiments of the application further disclose a vehicle, which may include a controller and at least one steering wheel, and the at least one steering wheel is configured to drive the vehicle to perform translational movement and rotary movement. In some embodiments, the vehicle may further include a distance detection sensor, which is configured to detect the first distance between the vehicle and the first track, and the second distance between the vehicle and the second track. The description of the distance detection sensor and the steering wheel refer to the above embodiments, which is not repeated here.

Referring to FIG. 13, FIG. 13 is a structure diagram of a controller according to an embodiment of the application. As illustrated in FIG. 13, the controller 1300 may include: a memory 1310 storing executable program code; a processor 1320 coupled to the memory 1310; where, the processor 1320 calls the executable program code stored in the memory 1310 to perform any vehicle control method disclosed in the embodiments of the application.

Embodiments of the application discloses a non-volatile computer-readable storage medium, storing a computer program, the computer program is executed by one or more processors to implement any vehicle control method disclosed in the embodiments of the application.

It is to be understood that “one example” or “an example” mentioned throughout the specification means that specific features, structures or characteristics relating to the example are included in at least one example of the application. Therefore, “in one example” or “in an example” appearing at different positions of the whole specification does not necessarily refer to the same example. In addition, the specific features, structures or characteristics may be combined in one or more examples in any appropriate manner. Those skilled in the art should also understand that the embodiments described in the specification are all optional, and the involved actions and modules are not necessarily required by the application.

It should be understood that in each embodiment of the application, the serial number of each of the above processes does not imply an inevitable sequence of the order of execution, and the order of execution of each process shall be determined by its function and inherent logic without constituting any limitation on the implementation process of the embodiments of the application.

The units described as separate parts may be or may be not physically separated, and the part displayed as a unit may be or may be not a physical unit, i.e., may be located at one place or distributed on multiple network units. Part or all of the units may be selected according to actual requirements to implement the objectives of the solutions in the examples.

In addition, different functional units in different examples of the application may be integrated into one processing unit, or each unit may be used as a separate unit, or two or more units may be integrated into one unit. The above integrated unit may be implemented in the hardware form or in the form of hardware and software functional units.

When the integrated unit in the application is implemented in the form of a software function module and sold or used as an independent product, the integrated unit may also be stored in a computer-readable storage medium. Based on such understanding, the technical solution of the application or the part that contributes to the existing technology, or all or part of the technical solution, can be embodied in the form of a software product. The computer software product is stored in a memory and includes a number of requests for a computer device (which may be a personal computer, a server or a network device, or the like, in particular a processor in the computer device) to perform some or all of the steps of the above methods of each embodiment of the application.

Technicians in the field can understand that all or part of the steps in the various methods described in the application can be completed by instructing relevant hardware with a program, which can be stored in a computer-readable storage medium. The storage medium includes Read-Only Memory (ROM), Random Access Memory (RAM), Programmable Read-Only Memory (PROM), Erasable Programmable Read Only Memory (EPROM), One-time Programmable Read-Only Memory (OTPROM), Electrically-Erasable Programmable Read-Only Memory (EEPROM), Compact Disc Read-Only Memory (CD-ROM) or other optical disk storage, magnetic disk storage, magnetic tape storage, or any other computer-readable medium capable of carrying or storing data.

The above provides a detailed introduction to a vehicle control method and apparatus, an electronic device, and a storage medium disclosed in embodiments of the application. Although the principles and implementations of the embodiments of the application are described by using specific examples herein, the foregoing descriptions of the embodiments are only intended to help understand the method and core idea of the application. A person skilled in the art may make modifications to the specific implementations and application range according to the idea of the application. In conclusion, the content of the specification is not to be construed as a limitation to the application.

What is claimed is:

1. A vehicle control method, applied to a vehicle comprising at least one steering wheel, wherein the vehicle is drivable between a first track and a second track, and the method comprises:
detecting a first distance between the vehicle and the first track, and detecting a second distance between the vehicle and the second track;
determining, according to the first distance and the second distance, offset information of a symmetrical centerline of the vehicle relative to a track centerline; wherein the first track and the second track are axisymmetric with respect to the track centerline;
determining, according to the offset information and position information corresponding to a to-be-controlled steering wheel, a first rotation angle control quantity of the to-be-controlled steering wheel; wherein the position information corresponding to the to-be-controlled steering wheel is used to indicate a set position of the to-be-controlled steering wheel on the vehicle, and the to-be-controlled steering wheel is any one of the at least one steering wheel; and
controlling, according to the first rotation angle control quantity, rotation of the to-be-controlled steering wheel, to change a travel direction of the to-be-controlled steering wheel, such that during travel of the vehicle, the symmetrical centerline of the vehicle overlaps with the track centerline.

2. The method according to claim 1, wherein determining, according to the offset information and the position information corresponding to the to-be-controlled steering wheel, the first rotation angle control quantity of the to-be-controlled steering wheel comprises:
calculating, according to the offset information, a second rotation angle control quantity, wherein the second rotation angle control quantity corresponds to an angle that the symmetrical centerline needs to rotate; and
determining, according to the second rotation angle control quantity and the position information corresponding to the to-be-controlled steering wheel, the first rotation angle control quantity of the to-be-controlled steering wheel.

3. The method according to claim 2, wherein the vehicle further comprises two directional wheels, a line connecting centers of the two directional wheels is perpendicular to the symmetrical centerline, the position information corresponding to the to-be-controlled steering wheel comprises coordinate information of a center point of the to-be-controlled steering wheel in a preset planar coordinate system, a first axis direction of the preset planar coordinate system is parallel to the symmetrical centerline of the vehicle, a second axis direction of the preset planar coordinate system is perpendicular to the symmetrical centerline, and an origin of the preset planar coordinate system is a midpoint of the line connecting the centers of the two directional wheels; and
determining, according to the second rotation angle control quantity and the position information corresponding to the to-be-controlled steering wheel, the first rotation angle control quantity of the to-be-controlled steering wheel comprises:
in a case where the center point of the to-be-controlled steering wheel is not on the symmetrical centerline, according to the position information corresponding to the to-be-controlled steering wheel and the second rotation angle control quantity, determining the first rotation angle control quantity of the to-be-controlled steering wheel.

4. The method according to claim 2, wherein determining, according to the second rotation angle control quantity and the position information corresponding to the to-be-controlled steering wheel, the first rotation angle control quantity of the to-be-controlled steering wheel comprises:
in a case where a center point of the to-be-controlled steering wheel is on the symmetrical centerline, determining the second rotation angle control quantity as the first rotation angle control quantity of the to-be-controlled steering wheel.

5. The method according to claim 2, wherein the offset information comprises a deflection steering angle of a target point on the symmetrical centerline and a distance vector of the target point from the track centerline;
calculating, according to the offset information, the second rotation angle control quantity comprises:
determining a first angle corresponding to a second ratio, wherein the second ratio is a ratio of the distance vector to a preset convergence parameter, and the first angle is an arctangent value of the second ratio; and
determining, according to the first angle and the deflection steering angle, the second rotation angle control quantity.

6. The method according to claim 5, wherein determining, according to the first angle and the deflection steering angle, the second rotation angle control quantity comprises:
in a case where a travel direction of the vehicle is a forward direction, calculating a first difference value between an opposite number of the deflection steering angle and the first angle, and determining the first difference value as the second rotation angle control quantity for the vehicle; and
in a case where a travel direction of the vehicle is a backward direction, calculating a second difference value between the deflection steering angle and the first angle, and determining the second difference value as the second rotation angle control quantity for the vehicle.

7. The method according to claim 1, wherein the first distance comprises a first sub-distance from a first position of the vehicle to the first track in a width direction of the vehicle, and a second sub-distance from a second position of the vehicle to the first track in the width direction, the second distance comprises a third sub-distance from a third position of the vehicle to the second track in the width direction, and a fourth sub-distance from a fourth position of the vehicle to the second track in the width direction; a line connecting the first position and the third position, a line connecting the second position and the fourth position, and the width direction are all perpendicular to the symmetrical centerline of the vehicle; and the offset information of the vehicle comprises a deflection steering angle of a target point on the symmetrical centerline and a distance vector of the target point from the track centerline; wherein
determining, according to the first distance and the second distance, offset information of the symmetrical centerline of the vehicle relative to the track centerline comprises:
calculating a third difference value between the first sub-distance and the third sub-distance, and a fourth difference value between the second sub-distance and the fourth sub-distance;
determining, according to the third difference value, the fourth difference value, and a third distance, the deflection steering angle of the target point on the symmetrical centerline, wherein the third distance is a distance between the second position and the first position in a symmetrical centerline direction of the vehicle; and
determining, according to the deflection steering angle and the third difference value, a distance vector of the target point from the track centerline, wherein the target point is an intersection point between the symmetrical centerline and the line connecting the first position and the third position.

8. The method according to claim 1, wherein the vehicle comprises an angular motion detection sensor, determining, according to the first distance and the second distance, offset information of the symmetrical centerline of the vehicle relative to the track centerline comprises:
determining a travel direction of the vehicle through the angular motion detection sensor, and according to the travel direction of the vehicle and a difference value between the first distance and the second distance, determining offset information of the symmetrical centerline of the vehicle relative to the track centerline.

9. The method according to claim 1, wherein determining, according to the offset information and position information corresponding to the to-be-controlled steering wheel, the first rotation angle control quantity of the to-be-controlled steering wheel comprises:
determining, according to the offset information and position information of the to-be-controlled steering wheel, first offset information corresponding to the to-be-controlled steering wheel, wherein the first offset information comprises a first distance vector between the set position of the to-be-controlled steering wheel and the track centerline, and a first deflection steering angle between a current travel direction of the to-be-controlled steering wheel and the track centerline; and
determining, according to the first offset information, the first rotation angle control quantity of the to-be-controlled steering wheel.

10. The method according to claim 2, wherein the vehicle is rotatable around a rotation center, and there is a target point on the symmetrical centerline, and there is an end point on the track centerline,
determining, according to the second rotation angle control quantity and the position information corresponding to the to-be-controlled steering wheel, the first rotation angle control quantity of the to-be-controlled steering wheel comprises:
determining, through a path planning algorithm, a second rotation angle corresponding to each path point in a path of the vehicle moving from the target point to the end point;
calculating, according to a position relationship of the to-be-controlled steering wheel relative to the rotation center, and a position relationship of the target point relative to the rotation center, a conversion relationship between a second rotation angle corresponding to the second rotation angle control quantity and a first rotation angle corresponding to the first rotation angle control quantity,
calculating, according to the second rotation angle and the conversion relationship, the first rotation angle, and
determining, according to the first rotation angle, the first rotation angle control quantity of the to-be-controlled steering wheel.

11. The method according to claim 1, wherein a chassis of the vehicle is provided with at least one steering wheel and at least one directional wheel, the at least one directional wheel is configured to drive the vehicle to perform translational movement, the vehicle is configured to send the first rotation angle control quantity to the to-be-controlled steering wheel of the at least one steering wheel, to drive the to-be-controlled steering wheel to rotate, to change a travel direction of the to-be-controlled steering wheel, thereby changing a travel direction of the vehicle.

12. The method according to claim 1, wherein the to-be-controlled steering wheel comprises a steering motor, a first transmission mechanism, and a steering wheel body, wherein the first transmission mechanism is respectively connected with the steering motor and the steering wheel body, and the steering motor is configured to receive the first rotation angle control quantity, rotate according to the first rotation angle control quantity, and drive the steering wheel body to rotate through the first transmission mechanism, to change a travel direction of the to-be-controlled steering wheel.

13. The method according to claim 12, wherein the to-be-controlled steering wheel further comprises a drive motor and a second transmission mechanism, wherein the second transmission mechanism is respectively connected to the drive motor and the steering wheel body, the drive motor is configured to drive the steering wheel body to rotate through the second transmission mechanism to drive the vehicle to perform translational movement, and the vehicle is configured to send a rotation speed instruction to the drive motor through a Controller Area Network, CAN, interface, and control a rotation speed of the drive motor to control a translation speed of the vehicle.

14. The method according to claim 1, wherein the vehicle comprises a first distance detection sensor arranged on a first side surface of the vehicle and a second distance detection sensor arranged on a second side surface of the vehicle, and
detecting the first distance between the vehicle and the first track, and detecting the second distance between the vehicle and the second track comprises:
detecting the first distance between the vehicle and the first track through the first distance detection sensor, and detecting the second distance between the vehicle and the second track through the second distance detection sensor.

15. The method according to claim 1, wherein determining, according to the first distance and the second distance, offset information of the symmetrical centerline of the vehicle relative to the track centerline comprises:
determining, by the vehicle, the travel direction of the vehicle through an angular motion detection sensor,
calculating a difference value between the first distance and the second distance as a fifth difference value, and
determining, according to the travel direction of the vehicle and the fifth difference value, offset information of the symmetrical centerline of the vehicle relative to the track centerline.

16. The method according to claim 1, wherein determining, according to the offset information and the position information corresponding to the to-be-controlled steering wheel, the first rotation angle control quantity of the to-be-controlled steering wheel comprises:
determining, according to the offset information and the position information corresponding to the to-be-controlled steering wheel, a first rotation angle that the to-be-controlled steering wheel needs to rotate, and
determining, according to the first rotation angle, the first rotation angle control quantity.

17. A vehicle, wherein the vehicle is drivable between a first track and a second track, and the vehicle comprises:
at least one steering wheel, being used to drive the vehicle to perform translational movement and rotary movement; and
a memory and a processor, wherein the memory stores a computer program, and when the computer program is executed by the processor, the processor is enabled to perform operations comprising:
obtaining a first distance between the vehicle and the first track, and obtaining a second distance between the vehicle and the second track;
determining, according to the first distance and the second distance, offset information of a symmetrical centerline of the vehicle relative to a track centerline; wherein the first track and the second track are axisymmetric with respect to the track centerline;
determining, according to the offset information and position information corresponding to a to-be-controlled steering wheel, a first rotation angle control quantity of the to-be-controlled steering wheel; wherein the position information corresponding to the to-be-controlled steering wheel is used to indicate a set position of the to-be-controlled steering wheel on the vehicle, the to-be-controlled steering wheel is any one of the at least one steering wheel; and
controlling, according to the first rotation angle control quantity, rotation of the to-be-controlled steering wheel, to change a travel direction of the to-be-controlled steering wheel, such that during travel of the vehicle, the symmetrical centerline of the vehicle overlaps with the track centerline.

18. The method according to claim 17, wherein determining, according to the offset information and position information corresponding to the to-be-controlled steering wheel, the first rotation angle control quantity of the to-be-controlled steering wheel comprises:
calculating, according to the offset information, a second rotation angle control quantity, wherein the second rotation angle control quantity corresponds to an angle that the symmetrical centerline needs to rotate; and
determining, according to the second rotation angle control quantity and the position information corresponding to the to-be-controlled steering wheel, the first rotation angle control quantity of the to-be-controlled steering wheel.

19. The method according to claim 18, wherein the offset information comprises a deflection steering angle of a target point on the symmetrical centerline and a distance vector of the target point from the track centerline;
calculating, according to the offset information, the second rotation angle control quantity comprises:
determining a first angle corresponding to a second ratio, wherein the second ratio is a ratio of the distance vector to a preset convergence parameter, and the first angle is an arctangent value of the second ratio; and
determining, according to the first angle and the deflection steering angle, the second rotation angle control quantity.

20. A non-volatile computer-readable storage medium, storing a computer program, the computer program is executed by one or more processors to perform operations comprising:
obtaining a first distance between a vehicle and a first track, and obtaining a second distance between the vehicle and a second track
determining, according to the first distance and the second distance, offset information of a symmetrical centerline of the vehicle relative to a track centerline; wherein the first track and the second track are axisymmetric with respect to the track centerline;
determining, according to the offset information and position information corresponding to a to-be-controlled steering wheel on the vehicle, a first rotation angle control quantity of the to-be-controlled steering wheel; wherein the position information corresponding to the to-be-controlled steering wheel is used to indicate a set position of the to-be-controlled steering wheel on the vehicle; and
controlling, according to the first rotation angle control quantity, rotation of the to-be-controlled steering wheel, to change a travel direction of the to-be-controlled steering wheel, such that during travel of the vehicle, the symmetrical centerline of the vehicle overlaps with the track centerline.
